(19) United States
(12) Patent Application Publication
(10) Pub. No.: US 2022/0057295 A1
(43) Pub. Date: Feb. 24, 2022

(54) SWEPT PATTERN PROBABILITY CALCULATION FOR SPEED AND DEFECT IDENTIFICATION

(71) Applicant: AKTIEBOLAGET SKF, GOTEBORG (SE)

(72) Inventor: Allan Thomson, Lanark (GB)

(21) Appl. No.: 16/995,986

(22) Filed: Aug. 18, 2020

(51) Int. Cl. G01M 13/045; F16C 19/52

(52) U.S. Cl. CPC G01M 13/045; F16C 19/527

(57) ABSTRACT

A method and system is provided for performing speed and defect identification of a component such as, for example, a bearing. The method can be implemented by a computer, such that the computer receives from one or more sensors condition monitoring data. The computer sweeps patterns along a speed range against the condition monitoring data and multiplies each pattern component of the patterns by a matching environmental spectral component. The computer, then, adds the pattern components together to produce one or more results.

### BACKGROUND

A train can have many rail cars, each of which can have multiple axles and corresponding axle boxes. Each axle box can have installed therein bearings, whether from the same or different manufacturers. Overtime, bearings develop defects due to numerous causes (e.g., contamination, surface imperfections, lubrication issues, etc.), which can be detected within vibration harmonics of the bearings. The field of collecting and monitoring these vibration harmonics, along with addressing defects detected in these vibration harmonics, is referred to as condition monitoring.

Further, whether the conventional condition monitoring applications are on-line and off-line, installing, utilizing, and maintaining a shaft speed sensor in support of collecting and monitoring bearing vibration harmonics can be problematic and/or expensive. For example, conventional condition monitoring applications require knowledge of a shaft speed to within a few % of tolerance to identify vibration spectrum frequency components/symptoms associated with bearing defects within the bearing vibration harmonics. Even with knowledge of the approximate shaft speed, conventional condition monitoring applications are redundant or unreliable, and the bearing defect goes undetected by these applications.

In conventional condition monitoring applications, managing parameters which can affect shaft speed calculations such as wheel diameters for each axle-box, for example, and updating a database in a timely fashion is costly with respect to man-hours, while also being prone to errors.

### SUMMARY

According to one or more embodiments, a method is provided herein. The method can be implemented by a computer, such that the computer receives from one or more sensors condition monitoring data. The computer sweeps patterns along a speed range against the condition monitoring data and multiplies each pattern component of the patterns by a matching direct or interpolated environmental spectral component. The interpolated environmental spectral component can be determined by performing a linear or polynomial analysis that matches a pattern component to a corresponding environmental spectral component. The computer, then, adds the pattern components together by one or more methods to produce one or more results.

According to one or more embodiments, the above method can be implemented as a system, apparatus, and/or a computer program product.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 depicts a system in accordance with one or more embodiments;

FIG. 2 depicts a process flow in accordance with one or more embodiments;

FIG. 3 depicts a graph in accordance with one or more embodiments; and

FIG. 4 depicts an example algorithm in accordance with one or more embodiments.

### DETAILED DESCRIPTION

Embodiments herein relate to a swept pattern probability calculation (SPPC) for speed and defect identification within bearings. In accordance with one or more embodiments, an SPPC auto-detection algorithm can be implemented by one or more devices to auto-detect bearing defects on bearings and associated machinery without the need to know an exact shaft speed. The bearing defects on the bearings and the associated machinery can include, but are not limited to, when spalls or flakes of the bearing break off (e.g., by spalling and spallation) of a bearing raceway (inner or outer) and/or roller and/or a cage thereof, as a result of brinelling, false brinelling, corrosion, contamination, lack of lubrication, or excessive rolling pressure.

For example, because bearings of railway axle-boxes and the associated machinery can provide a vibration spectrum (e.g., bearing vibration harmonics) during use, defect components/symptoms can become present in the vibration spectrum as the bearing defects develop. The SPPC auto-detection algorithm utilizes inner and outer raceways, roller and/or cage defect specific patterns to identify the most probable defect components/symptoms present in railway axle-box bearings and the associated machinery, and identify the exact shaft speed. The exact shaft speed can be utilized to perform further diagnostic operations and/or degradation analysis. While embodiments herein are described with respect to railway axle-boxes, the embodiments herein are not limited thereto. That is, although embodiments herein relate to deal with rail condition monitoring errors such as wheel diameter management errors required to convert global position system (GPS) linear speed to shaft rotational speed, embodiments herein are suited to many condition monitoring applications across many industries where a tachometer or speed input is not fitted or available.

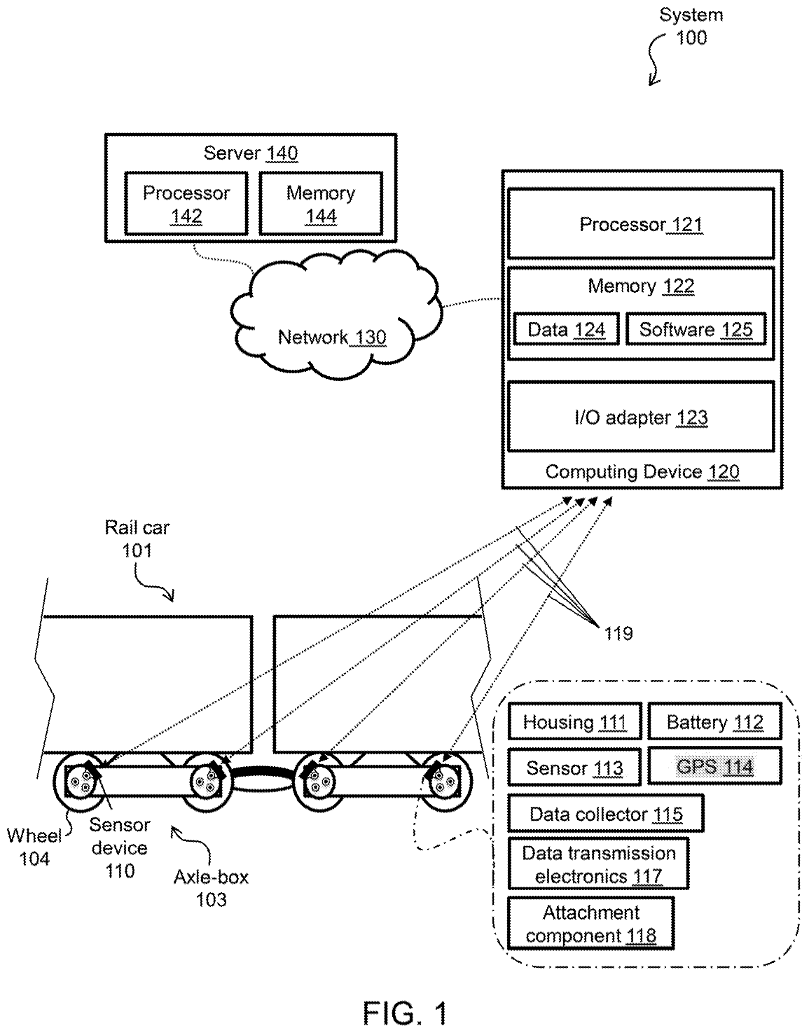

FIG. 1 depicts a system 100 in accordance with one or more embodiments. The system 100 includes at least one railcar 101 including at least one axle-box 103. The axle-box 103 includes one or more wheels 104 (e.g., a rail bogie wheel) attached thereto by fastening elements. Note that, while only a single axle-box is show, most railcars have two bogies hence two axles with eight wheels and eight axle-boxes attached thereto (for example, by a rail bogie wheel axle-box bearing). In general, a bearing housing of the axle-box 103 includes a rail bogie wheel axle-box bearing (e.g., the bearing(s)) that supports a corresponding wheel 104 and a bolt configuration that attaches the bearing housing to the axle-box 103. For example, trains typically include two to an excess of seventy rail cars 101, which means thousands of bearings can be present within a system 100 including a fleet of trains.

Further, a system 100 is generally shown in accordance with one or more embodiments. The system 100 can include an electronic, computer framework comprising and/or employing any number and combination of computing device and networks utilizing various communication technologies, as described herein. The system 100 can be easily scalable, extensible, and modular, with the ability to change to different services or reconfigure some features independently of others.

The system 100 includes at least one sensor device 110 of a plurality of condition monitoring sensor devices. Each sensor device 110 is an electronic device that can include a housing 111, a battery 112, at least one sensor 113 (e.g., transducers for vibration, temperature, etc.), a data collector 115 (e.g., a processor and a memory as described herein), a GPS 114, data transmission electronics 117 (e.g., a wireless modem and/or a near field communication (NFC) transponders), and an attachment component 118 that affixes the sensor device 110 to the wheel 104 (e.g., one of the plurality of securing bolts thereof). The attachment component 118 can be any bracket, flange, or the like that attaches the sensor device 110 to a mechanical system to be monitored.

For example, each sensor device 110 can be a compact, battery-operated device (e.g., using the battery 112) that measures static and dynamic data of the bearing of the wheel 104 (e.g., condition monitoring data) to which it is attached (e.g., specifically, being attached to least one of the fastening elements of that wheel 104). Via the data transmission electronics 117, each sensor device 110 can wirelessly transmit (as represented by double arrows 119) the condition monitoring data to devices, servers, and systems, such as a computing device 120.

In accordance with one or more embodiments, the memory of the data collector 115 and/or the data transmission electronics 117 of each sensor device 110 can store the condition monitoring and/or be associated with a unique sensor identifier. For instance, an NFC transponder can be pre-programmed with a unique sensor identifier associated with a wireless modem internal to a sensor device 110 and/or can be pre-programmed with details relating to that specific sensor and mounting location (e.g., whether it is mounted on or near a rail bogie wheel axle-box bearing). Further, at various pre-defined intervals and with speed gating (e.g., such as while the railcar 101 is moving and not parked parking in a rail yard, the sensor device 110 records the condition monitoring data.

The computing device 120 includes one or more central processing units (CPU(s)) (collectively or generically referred to as a processor 121). The processor 121 is coupled via a system bus to a memory 122 and various other components. The memory 122 can include a read only memory (ROM) and a random access memory (RAM). The ROM is coupled to the system bus and may include a basic input/output system (BIOS), which controls certain basic functions of the computing device 120. The RAM is read-write memory coupled to the system bus for use by the processor 121. The memory 122 stores data 124 and software 125.

The data 124 includes a set of values of qualitative or quantitative variables organized in various data structures to support and be used by operations of the software 125. In accordance with one or more embodiments, the memory 122 can accumulate from the sensor devices 110 and/or store the data 124 for use by the computing device 120. In this regard, for example, the data 124 can include the condition monitoring data (e.g., vibrations and temperatures of the bearings; bearing vibration harmonics), along with speed ranges (e.g., a range from a highest expected speed to a lowest expected speed along which a shaft of the axel box 103 can spin/rotate due to the bearings), speed values, root sum squared (RSS) values, bearing designations, unique sensor identifiers, pre-defined intervals for data accumulation, and one or more patterns specific to bearing defects. In one or more examples, the speed of a shaft can be defined as revolutions per minutes, as determined by GPS calculations that utilize approximated rail wheel diameters.

Note further that each of the one or more patterns can be a set of frequencies over time with respect to a specific bearing defect (e.g., as it develops). In this regard, the set of frequencies correlate to defect components/symptoms that are outside normal bearing operations. The patterns can be weighted, such that a maximum match (e.g., between a frequency and a defect component/symptom) gives a highest value with respect to the others. Each defect component/symptom in a pattern has maximum value of 1 but generally lower. Examples of the one or more patterns can include a ball pass frequency outer (BPFO) pattern that detects an outer race defect frequency, a ball pass frequency inner (BPFI) radial and axial loadings pattern that detects an inner race defect frequency, a ball spin frequency (BSF) pattern that detects a ball bearing defect frequency, and a cage fundamental train frequency (FTF) pattern that detects a cage defect frequency. Weighting of the patterns can be applied such that the BPFO pattern has 1×BPFO for every 5 harmonics, the BPFI radial and axial loadings pattern 1×BPFI for every 3 harmonics with 1×N sidebands, the BSF pattern has 1× or 2×BSF and few harmonics with FTF sidebands, and the cage FTF pattern has 1×FTF and a few harmonics.

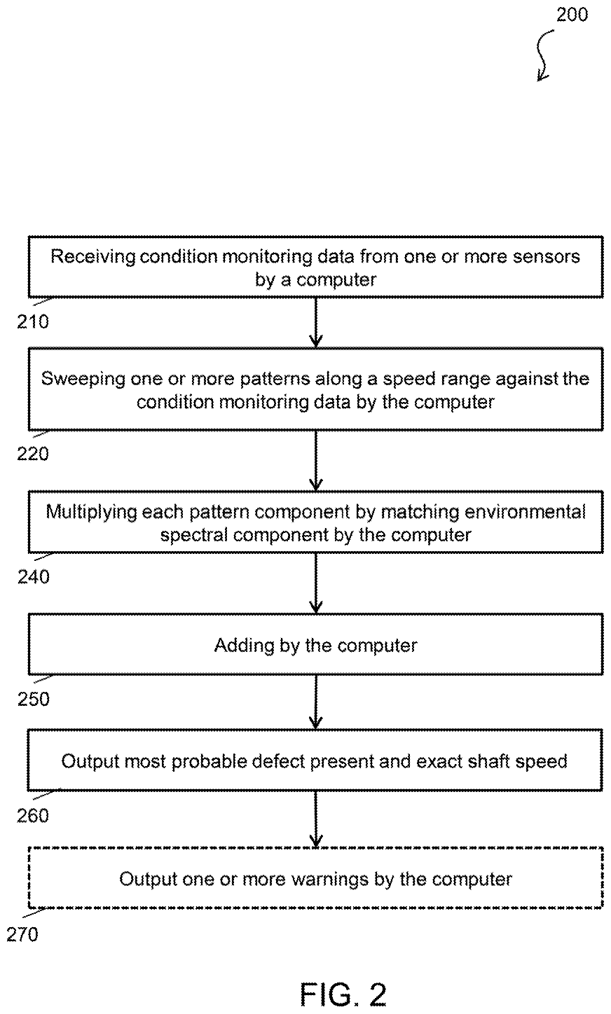

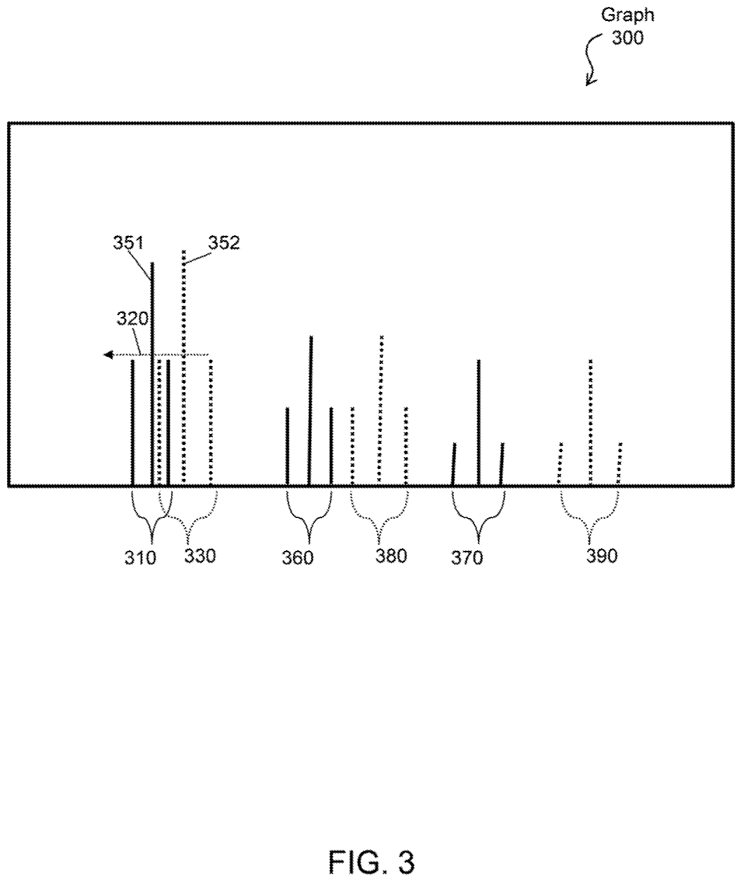

The software 125 is stored as instructions for execution on the processor 121. That is, the memory 122 is also an example of a tangible storage medium readable by the processor 121, where software is stored as instructions for execution by the processor 121 to cause the system 100 to operate, such as is described herein with reference to FIGS. 2-3. Note that the software 125 can reside anywhere within many types of condition monitoring systems and can provide storage, trending, and alarming operations, when a defect is present the SPPC provides the shaft speed, defect type, and frequency for the corresponding systems condition indicator (CI) calculation. For example, in accordance with one or more embodiments, the software can include an SPPC auto-detection algorithm, as described herein. In general, the SPPC auto-detection algorithm can be implemented by the computing device 120 to auto-detect bearing defects on the bearings of the axle box 103 (e.g., railway axle-box bearings) without the need to know accurate shaft speed, thus saving costs (e.g., man-hours) and reducing errors in managing constantly changing wheel diameters.

Further, when the SPPC auto-detection algorithm of the software is executed, the computing device 120 sweeps several specific weighted patterns through a specified speed range while calculating, for each speed step and each pattern type, RSS values of any correlations. In turn, a speed is identified as the speed that provided a largest value, and a defect type is identified by the specific pattern that gave that largest value. If no defect components/symptoms are present, then software does not take note of the speed (e.g., as it is not important). If defect components/symptoms are present, these identified defect components/symptoms are associated with the specific pattern to calculate the shaft speed, frequency of a bearing defect, and type of a bearing defect.

The computing device 120 includes one or more input/output (I/O) adapters 128 coupled to the system bus. The one or more I/O adapters 128 may include a small computer system interface (SCSI) adapter that communicates with the system memory 122 and/or any other similar component. The one or more I/O adapters 128 may include an NFC transponder that communicates with the NFC transponders of the sensor devices 110. For example, the one or more I/O adapters 128 can interconnect the system bus with a network 130, which may be an outside network, enabling the system 100 to communicate with other such systems (i.e., a server 140).

The system 100 also includes the network 130 and the server 140. The network 130 includes a set of computers connected together, sharing resources. The network 1280 can be any type of network, including a local area network (LAN), a wide area network (WAN), or the Internet, as described herein. The server 140 comprises a processor 142 and a memory 144 (as described herein) and provides various functionalities to the computing device 120, such as sharing and storing the data 124, providing processing resources, and/or performing computations (e.g., implementing the software 125).

In accordance with one or more embodiments, for example, the server 140 can be a cloud hosted condition monitoring system that executes by the processor 142 the software (e.g., the software 125 including the SPPC auto-detection algorithm) stored in the memory 144. Further, at various pre-defined intervals (e.g., such as while the railcar 101 is parking in a rail yard at the end of use), the cloud hosted condition monitoring system of the server 140 downloads and stores the data (e.g., the data 124, including the unique sensor identifiers and/or the respective condition monitoring data) from the sensor devices 110. Thus, the software of the server 140 can use the data therein to perform similar operations to the software 125 of the computing device 120.

Turning now to FIG. 2, a process flow 200 implemented by the system 100 is depicted in accordance with one or more embodiments. The process flow 200 can be implemented by any component of the system 100. In general, with respect to the process flow 200, the speed is unknown while bearing details are known. That is, while an exact shaft speed (e.g., rpm) is unknown, the exact bearing details (e.g., the bearing defect frequencies) are known and operating within a certain band (e.g., a narrow band width of +/−10% and/or a wide band width of +/−40%). Note the band can be centre fixed or derived by GPS process. The process flow 200 can be further enhanced by “zeroing” the spectral carpet noise and peaks not identifiably higher than the carpet by various methods.

In convention condition monitoring, if the speed variance of a bearing is small, a fixed central speed is configured with a large search band (e.g., +/−5% or more); however, this can lead to false detections/alarms (e.g., false positives) as there is a larger probability of selecting spectral components from other sources than the defect. This then requires a lot of man-hours for the analyst to manually analyse the spectra and other machine information as to accept or discard the alarm. In contrast, the process flow 200 provides the technical effect and benefit of reducing false positives by using the certain band described herein.

The process flow 200 begins at block 210, a computer (e.g., the computing device 120 and/or the server 140) receives/accumulates condition monitoring data from one or more sensors (e.g., the sensors devices 110). In accordance with one or more embodiments, the condition monitoring data, along with other data described herein, can be transmitted (e.g., as represented by double arrows 119 in FIG. 1) from the sensor devices 110 to the computing device 120. More particularly, the condition monitoring data includes vibration harmonics of bearings. The computing device 120 can further forward through the network 130 the condition monitoring data, along with other data described herein, to the server 140. Thus, both the computing device 120 and the server 140 accumulate sufficient information to support execution of the process flow 200. The accumulation of the condition monitoring data can occur at pre-defined intervals and, in some cases, the accumulation is performed twice a day (e.g., before the railcar 101 leaves a rail yard and after it returns).

At block 220, the computer (e.g., the computing device 120 and/or the server 140) sweeps one or more patterns along a speed range against the condition monitoring data. In accordance with one or more embodiments, the computing device 120 and/or the server 140 can have stored in their respective memories 122 and 144 a speed range. This speed range can be predefined from a highest expected speed to a lowest expected speed for the condition at the time of the measurement and include a plurality of speed steps. According to a non-limiting embodiment, the defect pattern is “swept” across a frequency range derived from a speed range in many iterations, where each iteration is referred to as a “speed step. Further, the computing device 120 and/or the server 140 can execute the software (e.g., the software 125) to sweep/apply these patterns at each speed step of the speed range, which calculates RSS values of speed/pattern correlations for each speed step and each pattern type (e.g., by a fraction of a bin at a time of the highest frequency component). One or more bins correspond to a spectrum, such that if you have 1000 hertz spectrum with 800 lines, each bin for each line has a value of how much vibration energy is associated with a center frequency of that bin (e.g., width of 1.25 hertz).

Turning to FIG. 3, a graph 300 is depicted according to one or more embodiments. The graph 300 illustrates an example of vibration harmonics 310 that are being swept 320 by a pattern 330 of an SPPC auto-detection algorithm. A vibration component frequency 351 is identified by a pattern component 352. In one or more embodiments, each pattern component 352 corresponds to several components defined by the number of orders and the number of sidebands, either side of each order. During the sweep, the pattern components 352 become coincidental to the vibration components 351. As the pattern components 352 become coincidental to the vibration components 351, the product obtained by multiplying the RSS (root sum squared) value of the pattern component weighting values by the corresponding spectral bin values they are aligned to in that sweep step reaches a maxima for that pattern. Accordingly, out of the several types of defect patterns, the one with the largest maxima value identifies the defect type most likely to be present. As shown, the graph 300 also illustrates other examples of vibration harmonics 360 and 370 being respectively swept by pattern components 380 and 380 of an SPPC auto-detection algorithm. In one or more non-limiting embodiments, each implemented bearing has a known or predetermined bearing defect frequency. Accordingly, an accurate speed can be identified by based, at least in part, on the known bearing defect frequencies ratios (i.e. bearing type), thereby allowing a narrow search band to identify defect frequency components (i.e., a frequency at which a defect of component occurs). In this manner, the number of false positives can be significantly reduced thereby increasing the confidence when a true positive is flagged by the software (e.g., the software 125). This increases the reliability of detection (e.g., alarm) by the software and reduces the number of man-hours required. Note also that pattern weighting is such that if more than one pattern crosses a set of spectral components only one having the best match (probability) gives the highest value.

At block 240, multiplying each pattern component (e.g., of the one or more patterns) by a matching environmental spectral component by the computer. In some example embodiments, multiplying each pattern component of the one or more patterns by a matching environmental spectral component is performed using interpolated matching environmental spectral components. In other example embodiments, multiplying each pattern component of the one or more patterns by a matching environmental spectral component is performed using quadratic peak interpolated matching environmental spectral peaks. At block 250, adding by the computer. The adding by the computer includes adding the pattern components together. In some example embodiments, the pattern components can be added together using a root sum squared (RSS). The adding identifies one or more results at operation 260. The results include, but are not limited to, a most probable defect, bearing defect frequency ratios, and an accurate shaft speed, i.e., the exact or actual shaft speed determined by the presence of the defect in the vibration signal and the known bearing defect ratios.

At dashed-block 270 (e.g., optional block), the computer outputs the one or more results. In this regard, a technician can readily ascertain concerns with any bearings being monitored by the computer and take remedial action (e.g., replace or repair the bearings). Note that if no defect components are present, it is not of importance that the speed is known. If other spectral components are present within the condition monitoring data (e.g., from the machine dynamics/mechanics), the other spectral components can also have a pattern associated therewith to calculate a speed in the absence of a bearing defect.

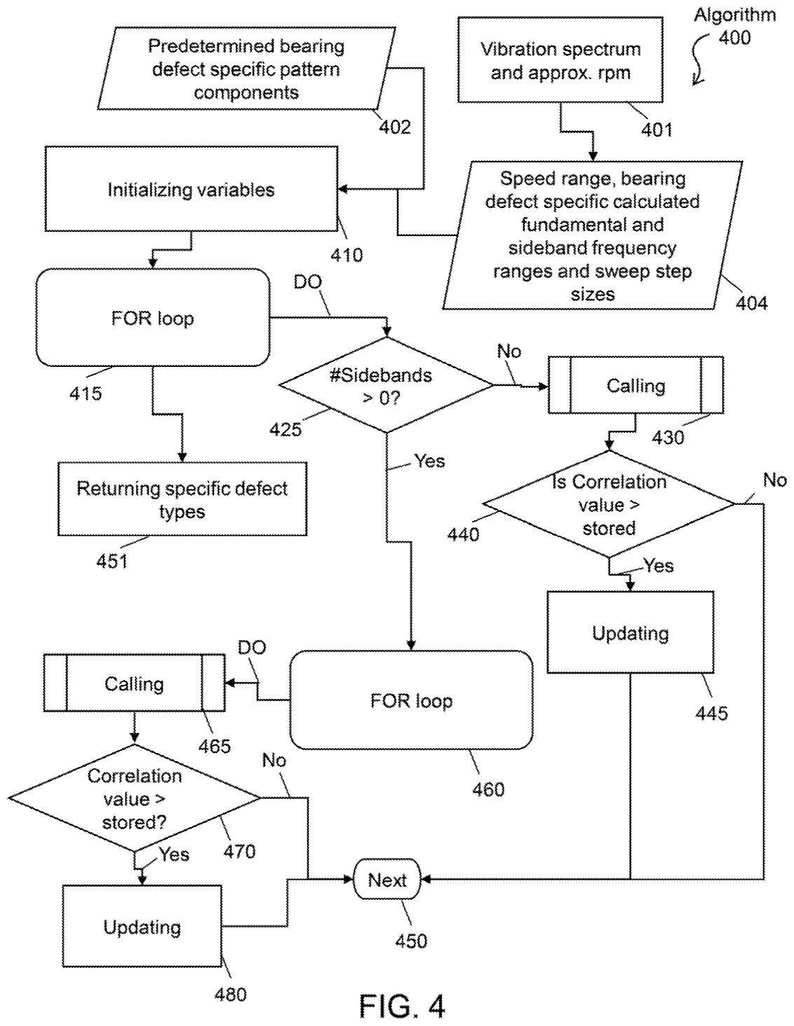

FIG. 4 depicts an example algorithm 400 in accordance with one or more embodiments. The example algorithm 400 begins at blocks 401, 402 and 404, where initial conditioning monitoring data is received. The initial conditional monitoring data includes, but is not limited to, a vibration spectrum of enveloped acceleration measurement with respect to shaft rpm (as shown in block 401), predetermined bearing defect specific pattern components (as shown in block 402), calculated speed range, bearing defect specific calculated fundamental and sideband frequency ranges, and sweep step sizes (as shown in block 404). In one or more non-limiting embodiments, when the GPS has an error range (e.g., +/−5%) and the wheel diameter has an error value (e.g., +/−5% from the stated diameter used to calculate RPM (shaft speed)), then the speed range to sweep the patterns through includes an acceptable minimum error value based, at least in part, on the GPS error range and wheel diameter error value, which in this example would be at least about +/−10%.

Then, at block 410, the example algorithm 400 initializes variables. For example, a correlation value, fundamental frequency, and a sideband frequency are each initialized to zero. At block 415, a FOR loop is entered for each vibration harmonic of a bearing. More particularly, for a fundamental range (low to high), the example algorithm 400 steps through fundamental step sizes to sweep patterns across the vibration harmonics. The FOR loop includes, at decision block 425 (as shown by the DO arrow), determining whether a number of sidebands is greater than zero. If the number of sidebands is not greater than zero, the example algorithm 400 proceeds to block 430 (e.g., following the “No” arrow).

At block 430, a correlate function is called, and at decision block 440, it is determined whether any of the correlation values are greater than stored values. If the correlation values are greater than stored values, the example algorithm 400 proceeds to block 445 (e.g., following the “Yes” arrow). Then, the example algorithm 400 goes to the next pattern at block 450 by returning to the block 415. Upon returning to block 415, the example algorithm 400 returns specific defect types (e.g., for any identified correlation value, fundamental frequency, and side band frequency; as shown at block 451).

At block 445, the correlation value and frequencies are updated. If the correlation values of the sidebands are not greater than stored values, the example algorithm 400 proceeds to block 450 (e.g., following the “No” arrow).

Returning to decision block 425, if the number of sidebands are greater than zero, the example algorithm 400 proceeds to block 460 (e.g., following the “Yes” arrow). At block 460, another FOR loop is entered for each vibration harmonic of a bearing. More particularly, for a sideband range (low to high), the example algorithm 400 steps through sideband step sizes to sweep patterns across the vibration harmonics. At block 465, a correlate function is called. At decision block 470, it is determined whether any of the correlation values are greater than stored values. If the correlation values are greater than stored values, the example algorithm 400 proceeds to block 450 (e.g., following the “No” arrow). If the correlation values are greater than stored values, the example algorithm 400 proceeds to block 480 (e.g., following the “Yes” arrow). At block 480, the correlation value and frequencies are updated. Then, the example algorithm 400 proceeds to block 450.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a computer from one or more sensors, condition monitoring data;
sweeping, by the computer, one or more patterns along a speed range against the condition monitoring data;
multiplying, by the computer, each pattern component of the one or more patterns by a matching environmental spectral component; and
adding, by the computer, the pattern components together to produce one or more results.

2. The method of claim 1, wherein the condition monitoring data includes bearing vibration harmonics.

3. The method of claim 1, wherein the one or more sensors measures, records, and transmits the condition monitoring data of a bearing.

4. The method of claim 1, wherein the speed range is predefined from a highest expected speed to a lowest expected speed and include a plurality of speed steps.

5. The method of claim 1, wherein the one or more results includes at least one of a shaft speed, a most probable defect, and a most probable defect frequency.

6. The method of claim 1, wherein the multiplying, by the computer, each pattern component of the one or more patterns by a matching environmental spectral component is performed using interpolated matching environmental spectral components.

7. The method of claim 1, wherein the multiplying, by the computer, each pattern component of the one or more patterns by a matching environmental spectral component is performed using quadratic peak interpolated matching environmental spectral peaks.

8. The method of claim 1, wherein the adding, by the computer, the pattern components together is performed using a root sum squared (RSS) method.

9. A computer program product comprising a computer readable storage medium having program instructions embodied therewith, the program instructions executable by a computer to cause:
receiving, by a computer from one or more sensors, condition monitoring data;
sweeping, by the computer, one or more patterns along a speed range against the condition monitoring data;
multiplying, by the computer, each pattern component of the one or more patterns by a matching environmental spectral component; and
adding, by the computer, the pattern components together to produce one or more results.

10. The computer program product of claim 7, wherein the condition monitoring data includes bearing vibration harmonics.

11. The computer program product of claim 7, wherein the one or more sensors measures, records, and transmits the condition monitoring data of a bearing.

12. The computer program product of claim 7, wherein the speed range is predefined from a highest expected speed to a lowest expected speed and include a plurality of speed steps.

13. The computer program product of claim 7, wherein the one or more results includes a shaft speed and a most probable defect.

14. The method of claim 9, wherein the multiplying, by the computer, each pattern component of the one or more patterns by a matching environmental spectral component is performed using interpolated matching environmental spectral components.

15. The method of claim 9, wherein the multiplying, by the computer, each pattern component of the one or more patterns by a matching environmental spectral component uses quadratic peak interpolated matching environmental spectral peaks.

16. The method of claim 9, wherein the adding, by the computer, the pattern components together is performed using a root sum squared (RSS) method.

17. A system comprising:
one or more sensors configured to output condition monitoring data; and
a computer in signal communication with the one or more sensors to receive the condition monitoring data, the computer configured to perform operations comprising:
sweep one or more patterns along a speed range against the condition monitoring data;
multiply each pattern component of the one or more patterns by a matching environmental spectral component; and
add the pattern components together to produce one or more results.

18. The system of claim 1, wherein the condition monitoring data includes bearing vibration harmonics.

19. The system of claim 1, wherein the one or more sensors measures, records, and transmits the condition monitoring data of a bearing.

20. The system of claim 1, wherein the speed range is predefined from a highest expected speed to a lowest expected speed and include a plurality of speed steps.
